(19) United States
(12) Patent Application Publication
(10) Pub. No.: US 2022/0372969 A1
(43) Pub. Date: Nov. 24, 2022

(54) METHOD AND APPARATUS FOR MOUNTING A DIAPHRAGM OF A PUMP

(71) Applicant: Graco Minnesota Inc., Minneapolis, MN (US)

(72) Inventor: Bradley H. Hines, Andover, MN (US)

(21) Appl. No.: 17/733,390

(22) Filed: Apr. 29, 2022

Related U.S. Application Data
(60) Provisional application No. 63/190,645, filed on May 19, 2021.

(51) Int. Cl. F04B 53/22; F04B 43/02

(52) U.S. Cl. CPC F04B 53/22; F04B 43/02

(57) ABSTRACT

A double diaphragm pump includes multiple diaphragms that are mounted for reciprocation. The diaphragms are connected for simultaneous movement to form a diaphragm assembly. A first one of the diaphragms is clamped between a housing cover and a center section. A pumping chamber is formed between the first diaphragm and the cover. Pressure in the first pumping chamber is decreased to draw the diaphragm assembly towards the first fluid cover, thereby drawing the second diaphragm into a mounting position relative to the center section. A second cover is then mounted to the center section to clamp the second diaphragm between the second cover and the center section.

### CROSS-REFERENCE TO RELATED APPLICATION(S)

This application claims priority to U.S. Provisional Application No. 63/190,645 filed May 19, 2021, and entitled “METHOD AND APPARATUS FOR MOUNTING A DIAPHRAGM OF A PUMP” the disclosure of which is hereby incorporated by reference in its entirety.

### BACKGROUND

The present disclosure relates generally to the assembly of pumps. More specifically, this disclosure relates to seating and sealing diaphragms of a double diaphragm pump.

In a double diaphragm pump, in which the diaphragms are directly or indirectly mechanically linked to flex and pump out of phase, one diaphragm will be in the pumping stroke and the other will be in the suction stroke. If the drive is unpowered, such as when not receiving pressurized driving air, then the diaphragms will equalize, causing the drive to sit in a centered position in which both diaphragms are slightly flexed. The diaphragm naturally wants to assume a non-flexed state, but an un-flexed diaphragm can be hard to seal against the diaphragm mount. In some cases, the diaphragm pump cannot be powered (e.g., pneumatically) to move the diaphragms to the appropriate positions for mounting and sealing because the diaphragms are not both sealed. In some examples, a blocker plate can be installed to direct the incoming air to only a drive chamber associated with the sealed diaphragm. Such a configuration requires at least partial disassembly of the pump to mount the plate for diaphragm mounting and then again to dismount the plate for pump operation. The diaphragm can also be mounted by physically forcing the second diaphragm into position, such as by large C-clamps. Such a mounting process is physically demanding and time intensive.

### SUMMARY

According to an aspect of the present disclosure, a method of mounting diaphragms to a pump includes reducing a pressure in a first pumping chamber defined by a first diaphragm and a first cover, the first cover mounted to a center section of the pump such that the first diaphragm is clamped between the first cover and the center section; drawing the first diaphragm in a first direction into the first pumping chamber by the reduced pressure to draw a second diaphragm linked to the first diaphragm in the first direction and place the second diaphragm in a mounting position relative to the center section; and mounting a second cover to the center section such that the second diaphragm is clamped between the second cover and the center section.

According to an additional or alternative aspect of the present disclosure, a method of mounting diaphragms of a pump includes mounting a first diaphragm on the pump; mounting a first cover to a center section of the pump to form a first chamber with the first diaphragm and the first cover; developing a partial vacuum within the first chamber, development of the partial vacuum moving a connector by the first diaphragm to move a second diaphragm to engage the second diaphragm with a receiver of the pump; and mounting a second cover to the receiver to secure the second diaphragm to the pump.

According to another additional or alternative aspect of the present disclosure, an apparatus for mounting a diaphragm of a pump includes a first cap configured to seal with a first neck of a housing cover of the pump; a second cap configured to seal with a second neck of the housing cover of the pump; and a fitting supported by the first cap, the fitting configured to allow airflow through the first cap.

### BRIEF DESCRIPTION OF THE DRAWINGS

FIG. 1A is an isometric partially exploded view of a pump assembly.

FIG. 1B is a side elevation partially exploded view of the pump assembly of FIG. 1A.

FIG. 2A is a cross-sectional view of the pump assembly of FIG. 1A in a first state.

FIG. 2B is a cross-sectional view of the pump assembly of FIG. 2A in a second state.

FIG. 2C is a cross-sectional view of the pump assembly of FIG. 2A in a third state.

FIG. 3A is an isometric view of the pump assembly of FIG. 2A in the first state.

FIG. 3B is an isometric view of the pump assembly of FIG. 2A in the third state.

### DETAILED DESCRIPTION

This disclosure concerns double diaphragm pumps. In particular, this disclosure concerns a system and method for seating and sealing a diaphragm on a double diaphragm pump. In double diaphragm pumps, the diaphragms are directly or indirectly mechanically linked to flex and pump out of phase, such that one diaphragm will be in the pumping stroke and the other will be in the suction stroke. A first one of the diaphragms can be positioned with its sealing bead in a groove associated with a center section of the pump and a cover is mounted to clamp the bead between the cover and center section. Positioning the first diaphragm causes the mechanically linked second diaphragm to shift axially outward away from the center section due to the first diaphragm being in a resting, unflexed state. The mounted diaphragm naturally wants to assume a non-flexed state, biasing the second diaphragm axially outward. To seat the second diaphragm, the pressure is reduced in the sealed pumping chamber formed by the first diaphragm and the first cover, such as by applying a vacuum generator to that chamber. The reduction in pressure draws the first diaphragm axially into the pumping chamber. Drawing the first diaphragm into the pumping chamber also draws the second diaphragm toward the center section because of the mechanical linkage between the two diaphragms. The bead of the second diaphragm seats in a groove on the center section and a second cover can be secured to the center section to sealingly mount the second diaphragm.

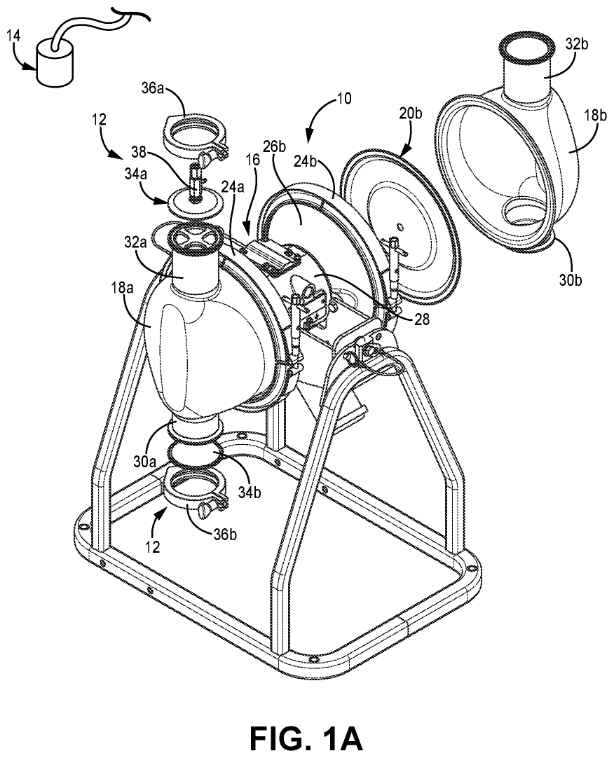

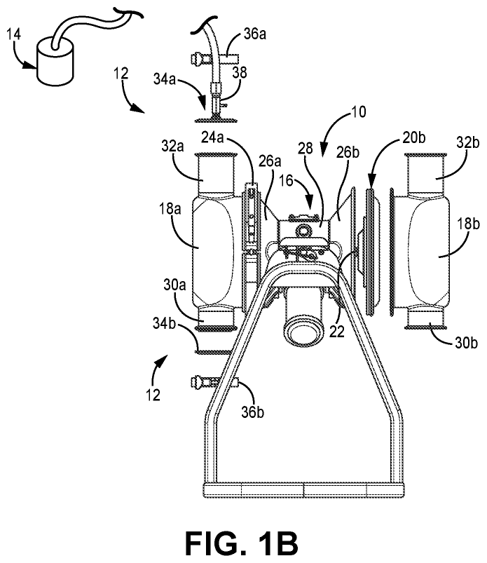

FIG. 1A is an isometric partially exploded view of pump assembly 10 and mounting kit 12. FIG. 1B is a side elevation partially exploded view of pump assembly 10 and mounting kit 12. FIGS. 1A and 1B will be discussed together. Vacuum source 14 is shown schematically in FIGS. 1A and 1B. Pump assembly 10 includes center section 16; covers 18a, 18b; diaphragms 20a, 20b (only diaphragm 20b shown in FIGS. 1A and 1B); shaft 22; and cover clamps 24a, 24b. Center section includes receivers 26a, 26b and center housing 28. Covers 18a, 18b respectively include inlet necks 30a, 30b and outlet necks 32a, 32b. Mounting kit 12 includes caps 34a, 34b and cap clamps 36a. 36b. Cap 34a includes fitting 38.

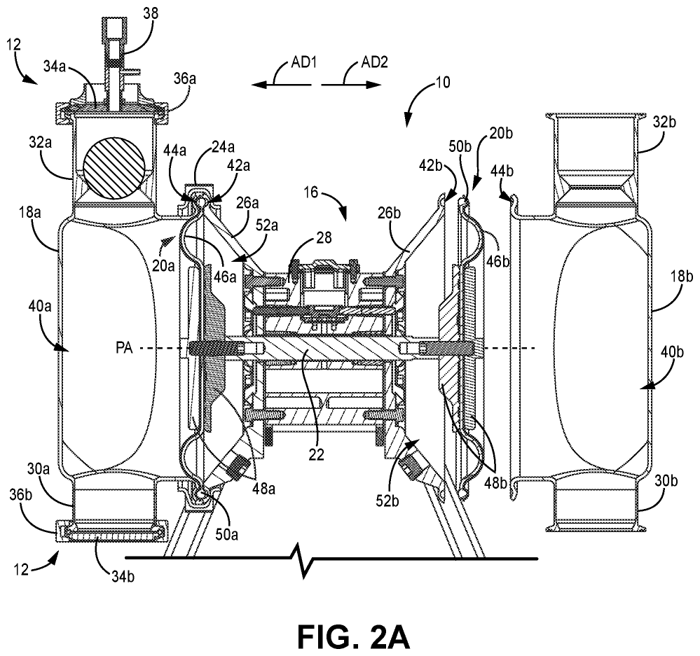

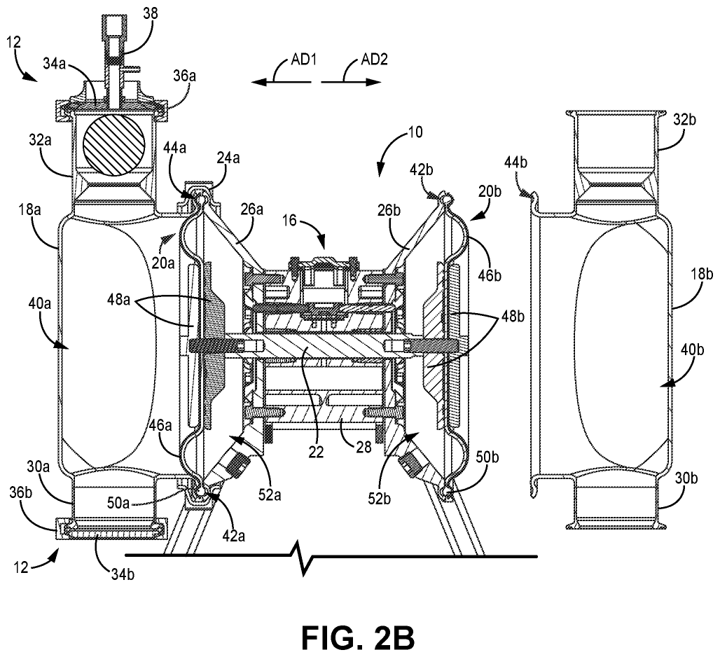

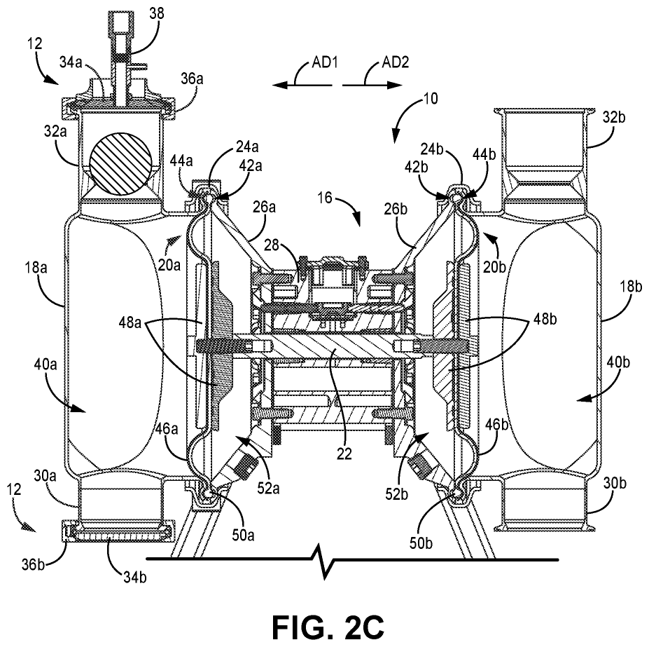

Pump assembly 10 includes two nearly identical sides that respectively include diaphragm 20a and diaphragm 20b. Each side includes a cover 18a, 18b, which covers 18a, 18b can also be referred to as housing covers. Covers 18a, 18b and diaphragms 20a, 20b define pumping chambers 40a, 40b (FIGS. 2A-2C) through which the process fluid is pumped by the pump assembly 10. Specifically, the process fluid is drawn from upstream through inlet necks 30a, 30b and driven downstream through outlet necks 32a, 32b by reciprocation of diaphragms 20a, 20b.

Diaphragm 20a is clamped between housing cover 18a and center section 16. Diaphragm 20b is similarly clamped between housing cover 18b and center section 16. More specifically, diaphragms 20a, 20b are clamped between housing covers 18a, 18b and receivers 26a, 26b of center section 16. Center section 16 can also be referred to as a body of the pump assembly 10. It is understood that receivers 26a, 26b can be formed separately from or integrally with a center housing 28 of center section 16. In the example shown, cover clamps 24a, 24b secure covers 18a, 18b to center section 16. It is understood, however, that covers 18a, 18b can be secured to center section 16 in any desired manner, such as by fasteners (e.g., bolts), among other options.

Inlet necks 30a, 30b allow pumped fluid to flow into pumping chambers 40a, 40b, respectively. In some examples, inlet necks 30a, 30b are connected to a common inlet manifold (not shown) such that each side of pump assembly 10 receives an inflow from a common upstream flow. Outlet necks 32a, 32b provide the pumped fluid downstream out of the pumping chambers 40a, 40b. In some examples, outlet necks 32a, 32b are connected to a common outlet manifold such that the flows from both sides of the pump assembly 10 combine downstream of the pumping chambers 40a, 40b to form a common downstream flow. Inlet checks can be disposed in the inlet necks 30a, 30b to prevent retrograde flow out of the pump assembly 10 through the inlet necks 30a, 30b. Outlet checks can be disposed in the outlet necks 32a, 32b to prevent retrograde flow into the pump assembly 10 through outlet necks 32a, 32b. For example, inlet checks and outlet checks can be formed as ball valves.

As shown in FIGS. 1A and 1B, during assembly of pump assembly 10 a first cover 18a is initially mounted to center section 16 to secure the first diaphragm 20a between cover 18a and center section 16. Cap 34a is mounted to a first one of the inlet neck 30a and the outlet neck 32a of the cover 18a that is first mounted to the center section 16. Cap 34b is mounted to a second one of the inlet neck 30a and outlet neck 32a that cover 18a is not mounted to. In the example shown, cap 34a is mounted to outlet neck 32a and cap 34b is mounted to inlet neck 30a. Mounting cap 34a to outlet neck 32a facilitates operation of the mounting kit 12 when the inlet checks and outlet checks are already installed on pump assembly 10.

Cap 34a seals outlet neck 32a to provide a fluid-tight seal at outlet neck 32. Cap 34b seals inlet neck 30 to provide a fluid-tight seal at inlet neck 30. In the example shown, caps 34a, 34b are secured to cover 18a by cap clamps 36a. 36b, respectively. While caps 34a, 34b are shown as mounted by way of cap clamps 36a. 36b, it is understood that caps 34a, 34b can be mounted and secured to cover 18a in any desired manner. For example, outlet neck 32a can include threading and cap 34a can be a threaded disk that threads into the threading of outlet neck 32a. Similarly, cap 34b can be a threaded disk that threads into the threading of inlet neck 30a.

While cap 34b is a plug that blocks and seals the inlet neck 30a, cap 34a includes one or more apertures for removing air from within cover 18a to develop a partial vacuum within the cover 18a. Cap 34b can be formed by a disk that plugs the neck that the cap 34b is mounted on to form an airtight seal and prevent flow through that neck. In some examples, cap 34b does not include any apertures through which air can flow. Fitting 38 is mounted to the disk forming cap 34a such that the only passage for flow from within cover 18a is through fitting 38. Also shown in FIG. 1A is vacuum source 14. Vacuum source 14 can be a pump (e.g., a compressor) that can develop a vacuum or a source of air which can cause air to exit from the pumping chamber 40a within the housing cover 18a. In some examples, fitting 38 can be configured to connect to a hose extending from vacuum source 14 and vacuum source 14 can be configured as a vacuum pump that draws air from the pumping chamber 40a. In other examples, fitting 38 can be a vacuum generator that itself draws air from the pumping chamber 40a, such as via the venturi effect and air flowing into and out of the fitting 38. In such an example, vacuum source 14 can that be an air compressor that drives compressed air to the fitting 38 to cause the vacuum generator formed by fitting 38 to draw the air out of the pumping chamber within cover 18a. In the case of a vacuum being generated by venturi effect, pressurized air flows through a first port on the fitting 38, passed an aperture that leads to a chamber within the housing cover 18, and out to a second port on the fitting 38. In each example discussed, a vacuum generator draws air from the pumping chamber 40a to reduce the pressure within that pumping chamber 40a. A partial vacuum is created in the pumping chamber 40a to draw diaphragm 20a in the first axial direction AD1, which draws diaphragm 20b in the first axial direction AD1 by the mechanical link between diaphragm 20a and diaphragm 20b.

The reduced pressure in the pumping chamber 40a draws diaphragm 20a in first axial direction AD1, drawing diaphragm 20b in the first axial direction AD1 due to the mechanical link between diaphragms 20a, 20b that is formed by shaft 22. Diaphragm 20b is drawn into a seated position on receiver 26b. The housing cover 18b can then be positioned on center section 16 to clamp the outer edge of diaphragm 20b between receiver 26b and housing cover 18b. Housing cover 18b is fixed to center section 16 to securely clamp the edge of the diaphragm 20b between housing cover 18b and receiver 26b. In the example shown, cover clamp 24b is secured on pump assembly 10 to fix housing cover 18b to center section 16. It is understood, however, that housing cover 18b can be fixed to center section 16 in any desired manner, such as by fasteners (e.g., bolts) extending through housing cover 18b into receiver 26b or through receiver 26b into housing cover 18b.

Mounting kit 12 provides significant advantages. Mounting kit 12 facilitates easy mounting of the second diaphragm, diaphragm 20b in the example discussed, by drawing air out of the already formed pumping chamber. Caps 34a, 34b are easily and quickly mounted to housing cover 18a and then air is drawn out of housing cover 18a to draw diaphragm 20b towards center section 16 for mounting due to the mechanical connection between diaphragms 20a, 20b. Mounting kit 12 does not require any disassembly of components of pump assembly 10 to route air or otherwise bias the diaphragm 20a to shift diaphragm 20b. Mounting kit 12 does not require large C-clamps or other mechanical components to try and bias and align the second diaphragm 20b for mounting. Mounting kit 12 facilitates easy mounting of the diaphragm 20b. Mounting kit 12 requires few components and can be quickly and easily applied to pump assembly 10 to mount the diaphragms. Pump assembly 10 can be placed in operation by simply removing mounting kit 12 after mounting the second diaphragm 20b and connecting inlet necks 30a, 30b to receive fluid from an upstream location and connecting outlet necks 32a, 32b to provide fluid to a downstream location. The user does not need to disassemble components of pump assembly 10, such as air routing components, that can be easily damaged or misplaced in order to route air to an interior chamber and bias diaphragm 20a. Instead, the mounting kit 12 is separate from the operating components of pump assembly 10 such that the interior components of pump assembly 10 can remain in an operational configuration throughout the mounting process.

FIG. 2A is a cross-sectional view of the pump assembly 10 of FIG. 1A in a first state. FIG. 2B is a cross-sectional view of the pump assembly 10 of FIG. 2A in a second state. FIG. 2C is a cross-sectional view of the pump assembly 10 of FIG. 2A in a third state. Pump assembly 10 includes center section 16; covers 18a, 18b; diaphragms 20a, 20b; and shaft 22. Receivers 26a, 26b and center housing 28 of center section 16 are shown. Covers 18a, 18b respectively include inlet necks 30a, 30b and outlet necks 32a, 32b. Receivers 26a, 26b respectively include receiver grooves 42a, 42b. Covers 18a, 18b respectively include cover grooves 44a, 44b. Diaphragm 20a includes membrane 46a and plates 48a. Bead 50a is formed at a circumferential edge of membrane 46a. Diaphragm 20b includes membrane 46b and plates 48b. Bead 50b is formed at a circumferential edge of membrane 46b. Mounting kit 12 is shown and includes caps 34a, 34b and cap clamps 36a. 36b. Cap 34a includes fitting 38.

Covers 18a, 18b are mounted to center section 16 to clamp diaphragms 20a, 20b between covers 18a, 18b and center section 16. Center section 16 includes receiver 26a on a first axial side of center housing 28 and receiver 26b on a second, opposite axial side of center housing 28. In the example shown, receivers 26a, 26b are mounted to center housing 28 by fasteners, though it is understood that pump assembly 10 can be formed in any desired manner, such as with receivers 26a, 26b integrally formed with center housing 28 or clamped to center housing 28.

Receiver grooves 42a, 42b are formed on receivers 26a, 26b, respectively. Cover grooves 44a, 44b are formed on covers 18a, 18b, respectively. Receiver groove 42a opposes cover groove 44a and bead 50a is clamped therebetween. Bead 50a is formed as an enlargement at the outer circumferential edge of diaphragm 20a. Bead 50a can be formed as a continuous bulge extending annularly about the outer edge of the membrane 46a or can be formed as a series of bulges disposed annularly about the outer edge of membrane 46a. Bead 50a is captured in receiver groove 42a and cover groove 44a to form a fluid tight seal therebetween.

Receiver groove 42b opposes cover groove 44b and bead 50b is clamped therebetween. Bead 50b is formed as an enlargement at the outer circumferential edge of diaphragm 20b. Bead 50b can be formed as a continuous bulge extending annularly about the outer edge of the membrane 46b or can be formed as a series of bulges disposed annularly about the outer edge of membrane 46b. Bead 50b is captured in receiver groove 42b and cover groove 44b to form a fluid tight seal therebetween.

Diaphragms 20a, 20b are connected to each other by shaft 22 extending therebetween. Shaft 22 can also be referred to as a connector as shaft 22 mechanically links diaphragm 20a and diaphragm 20b. Diaphragms 20a, 20b are connected to opposite ends of shaft 22 by fasteners extending into shaft 22. Shaft 22 extends through center housing 28 to connect to diaphragms 20a, 20b.

In the example shown, diaphragm 20a is formed by plates 48a disposed on opposite sides of membrane 46a. Membrane 46a extends radially outward from plates 48a, relative to a reciprocation axis of diaphragm 20a and is clamped between receiver 26a and cover 18a. In the example shown, diaphragm 20b is formed similar to diaphragm 20a and includes plates 48b disposed on opposite sides of membrane 46b. Membrane 46b extends radially outward from plates 48b, relative to a reciprocation axis of diaphragm 20b, and is clamped between receiver 26b and cover 18b. It is understood that diaphragm 20b can be configured differently from diaphragm 20a in other examples. In the example shown, diaphragms 20a, 20b are disposed coaxially on pump axis PA and are configured to reciprocate along pump axis PA during operation to pump the process fluid through pumping chambers 40a, 40b. As such, the reciprocation axes of diaphragms 20a, 20b are coaxial with the pump axis PA.

Pumping chamber 40a is formed within housing cover 18a and at least partially defined by diaphragm 20a. Process fluid is pumped through pumping chamber 40a by reciprocation of diaphragm 20a. The pumped material enters pumping chamber 40 through inlet neck 30a and exits pumping chamber 40a through outlet neck 32a. Check valves (not shown) are disposed in inlet neck 30a to prevent retrograde flow out of pumping chamber 40a and in outlet neck 32a to prevent retrograde flow into pumping chamber 40a. A ball of the outlet check of outlet neck 32a is shown in FIGS. 2A-2C. Air chamber 52a is disposed on an opposite side of diaphragm 20a from pumping chamber 40a. Air chamber 52a is formed within center section and, in the example shown, is at least partially defined by diaphragm 20a and receiver 26a. During operation, compressed air is provided to air chamber 52a to drive diaphragms 20a, 20b in the first axial direction AD1.

Pumping chamber 40b is formed within housing cover 18b and at least partially defined by diaphragm 20b. Process fluid is pumped through pumping chamber 40b by reciprocation of diaphragm 20b. The pumped material enters pumping chamber 40 through inlet neck 30b and exits pumping chamber 40b through outlet neck 32b. Check valves (not shown) are disposed in inlet neck 30b to prevent retrograde flow out of pumping chamber 40b and in outlet neck 32b to prevent retrograde flow into pumping chamber 40b. Air chamber 52b is disposed on an opposite side of diaphragm 20b from pumping chamber 40b. Air chamber 52b is formed within center section and, in the example shown, is at least partially defined by diaphragm 20b and receiver 26b. During operation, compressed air is provided to air chamber 52b to drive diaphragms 20a, 20b in the second axial direction AD2.

A valve, such as a shuttle assembly (not shown), is configured to alternatingly direct air to air chambers 52a, 52b. Compressed air is directed to air chamber 52a and vented from air chamber 52b to drive diaphragms 20a, 20b in first axial direction AD1. Compressed air is directed to air chamber 52b and vented from air chamber 52a to drive diaphragms 20a, 20b in second axial direction AD2.

During assembly, diaphragms 20a, 20b are connected to shaft 22, such as by fasteners that thread into shaft 22. Diaphragm 20a is positioned such that bead 50a is disposed in receiver groove 42a. Cover 18a is connected to receiver 26a such that bead 50a is captured within receiver groove 42a and cover groove 44a. Cover 18a is fixed to receiver 26a, by cover clamp 24a in the example shown. The first diaphragm mounted, which is diaphragm 20a in the example discussed, can typically be installed without any specialized tools. Diaphragm 20a naturally wants to assume a non-flexed state, which biases diaphragm 20b in second axial direction AD2 and away from receiver 26b.

In the first state shown in FIG. 2A, cover 18a is fixed to receiver 26a and diaphragm 20a is clamped between cover 18a and receiver 26a. Diaphragm 20b is spaced from receiver 26b and needs to be shifted in first axial direction AD1 for mounting. Mounting kit 12 is assembled on pump assembly 10 and operated to place diaphragm 20b in a desired position for mounting.

Cap 34a is mounted to outlet neck 32a in the example shown. Mounting cap 34a to outlet neck 32a allows the mounting procedure to proceed even when the check valves are already assembled to inlet neck 30a and outlet neck 32a. The inlet check valve is removed from inlet neck 30a if cap 34a is mounted to inlet neck 30a.

The disk of cap 34a is sealingly mounted to outlet neck 32a such that air can flow out of pumping chamber 40a only through cap 34a, and specifically through fitting 38 mounted to the disk of cap 34a. In the example shown, cap 34a is secured to outlet neck 32a by cap clamp 36a. As discussed above, while cap 34a is shown as clamped to cover 18a, cap 34a can be secured to cover 18a in any desired manner, such as by interfaced threading, among other options. Fitting 38 projects from cap 34a and is fluidly connected to the pumping chamber 40a within cover 18a.

Cap 34b is mounted to the opposite one of inlet neck 30a and outlet neck 32a from cap 34a. In the example shown, cap 34b is mounted to inlet neck 30a. The disk of cap 34b is sealingly mounted to inlet neck 30a. In the example shown, cap 34b is secured to inlet neck 30a by cap clamp 36b. As discussed above, while cap 34b is shown as clamped to cover 18a, cap 34b can be secured to cover 18a in any desired manner, such as by interfaced threading, among other options. With cap 34b mounted to inlet neck 30a and cap 34a mounted to outlet neck 32a, pumping chamber 40a is a sealed cavity and air can exit only through fitting 38 of cap 34a.

A vacuum source, such as vacuum source 14 (FIG. 1A), is connected to mounting kit 12 at fitting 38. For example, a hose that extends from the vacuum source can be connected to fitting 38. The vacuum source is powered, causing air to be drawn out of pumping chamber 40a through fitting 38. Drawing air out of the pumping chamber 40a lowers the pressure within the pumping chamber 40a, which reduced pressure pulls the diaphragm 20a in the first axial direction AD1. Pulling the diaphragm 20a in the first axial direction also pulls shaft 22 in the first axial direction AD1 due to the fixation of diaphragm 20a to shaft 22. Shaft 22 is also fixed to diaphragm 20b such that pulling diaphragm 20a in the first axial direction AD1 also pulls diaphragm 20b in the first axial direction AD1. Diaphragm 20b displaces in the first axial direction AD1 and is pulled against the receiver 26b.

The displacement flexes both of the diaphragms 20a, 20b, overcoming any resisting elastic forces and allowing the bead 50b of the diaphragm 20b to press against the receiver 26b and seat within receiver groove 42b. Such displacement places the pump assembly 10 in the second state shown in FIG. 2B.

With pump assembly 10b in the state shown in FIG. 2B, the housing cover 18b can be placed against the diaphragm 20b and secured to receiver 26b. Once the diaphragm 20b is in place, the housing cover 18b can be mounted on the center housing 28. In the example shown, housing cover 18b is mounted by clamping with cover clamp 24b. The bead 50b of diaphragm 20b is clamped within receiver groove 42b and cover groove 44b to mount and seal the diaphragm 20b. Pump assembly 10 is thus placed in the third, assembled state shown in FIG. 2C. Mounting kit 12 can be removed from cover 18a and inlet and outlet manifolds can be mounted to covers 18a, 18b to connect pump assembly 10 within a pumping system. The vacuum source can be deactivated and the pumping chamber 40a can be returned to atmospheric pressure after the second diaphragm 20b is mounted.

Use of the vacuum mounting kit 12 facilitates easy mounting and sealing of a diaphragm without operating the pump assembly 10 with pneumatic or other type of power, other than that provided by the vacuum source. As such, only the pumping chamber 40a is at a pressure other than atmospheric, while the normally pneumatically pressurized air chambers 52a, 52b within the center section 16 are not pressurized. Without the mounting kit 12, the diaphragm 20b must be moved into place by hand to overcome the elastic force generated by the diaphragm 20a which can be difficult to keep in place while attempting to finalize the seal in securing the cover 18b to the center section 16 with cover clamp 24b. Diaphragm 20b could also be moved into place by disassembling delicate components of pump assembly 10, installing air directing components within the pump assembly 10 to pressurize only the air chamber 52a, uninstalling those directing components, and reassembling the delicate air directing components of pump assembly 10, which risks damage to those delicate components of pump assembly 10 and, because the components are removed, creates a risk of misplacing of losing components of pump assembly 10. Disassembly is also time consuming and requires a skilled operator to ensure that components are reassembled correctly to operate the pump.

The reduced pressure in pumping chamber 40a provides a quick and efficient way to position diaphragm 20b at a desired location to facilitate assembly and mounting of housing cover 18. The pump assembly 10 can quickly be placed into operation after assembling housing cover 18 to center section 16 without requiring disassembly and reassembly of other components of pump assembly 10. In addition, a single mounting kit 12 can be configured for use on different pump assemblies having different configurations. Mounting kit 12 thereby provides an efficient and effective system for mounting diaphragms across a wide array of diaphragm pump configurations.

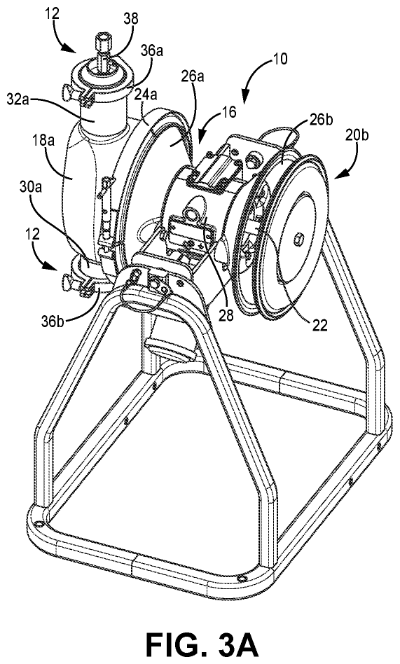

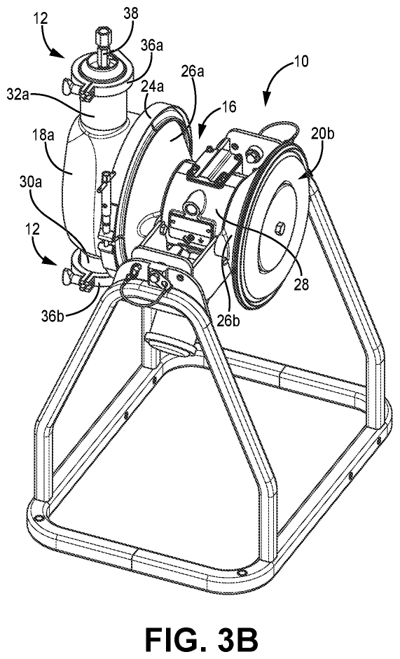

FIG. 3A is an isometric view of pump assembly 10 in the first state shown in FIG. 2A. FIG. 3B is an isometric view of pump assembly 10 in the second state shown in FIG. 2B. FIGS. 3A and 3B will be discussed together. As shown in FIG. 3A, diaphragm 20b is initially spaced from receiver 26b and must be shifted towards receiver 26b to seal against and mount to receiver 26b. Mounting kit 12 is assembled to pump assembly 10. Specifically, mounting kit 12 is mounted to cover 18a that is assembled to center section 16. A vacuum source, which can be a vacuum pump, source of compressed air, or other component configured to draw air from the pumping chamber, is connected to fitting 38, such as by a hose. The vacuum source can draw the air directly from the pumping chamber, in examples where the vacuum source is a vacuum pump, or can provide a flow of compressed air to fitting 38 and fitting 38 can be configured as a vacuum generator that draws the air from the pumping chamber. For example, fitting 38 can draw the air from the pumping chamber by the venturi effect in response to the compressed air flowing to the fitting 38.

Air is drawn out of the pumping chamber 40a (shown in FIGS. 2A-2C) through fitting 38. The reduced pressure in the pumping chamber causes the diaphragm 20a (shown in FIGS. 2A-2C) to shift in first axial direction AD1, which draws diaphragm 20b in first axial direction AD1 due to the mechanical connection between the diaphragms 20a, 20b, which mechanical connection is formed by shaft 22. Diaphragm 20b shifts to the mounting position on receiver 26b, as shown in FIG. 3B. In the state shown in FIG. 3B, the reduced pressure continues to be generated inside of the cover 18a. The reduced pressure maintains the diaphragm 20b in the desired position on receiver 26b for mounting of the cover 18b (shown in FIGS. 1A-2C) and clamping of diaphragm 20b between cover 18b and receiver 26b. The reduced pressure maintaining the diaphragm 20b in the desired mounting position allows the user to fix cover 18b on the center section 16 without concern about the diaphragm 20b unseating or being misaligned. The cover 18b can be mounted in any desired manner, such as by a clamp (e.g., cover clamp 24b (best seen in FIG. 1B)) or fasteners (e.g., bolts), among other options. After mounting cover 18b, diaphragm 20b is secured for pumping. The vacuum source can be deactivated and mounting kit 12 removed from cover 18a. Pump assembly 10 is then ready for connection to an upstream fluid source and downstream fluid destination for pumping operation.

Mounting kit 12 and the method of mounting the diaphragms to assemble pump assembly 10 provides significant advantages. Mounting kit 12 can be assembled to pump assembly 10 and removed from pump assembly 10 without requiring disassembly of other components of pump assembly 10. Mounting kit 12 thereby reduces the time required to mount both diaphragms 20a, 20b to pump assembly 10. Reducing the pressure within the cover 18a draws the opposite diaphragm 20b into a seated position and maintains the diaphragm 20b in the seated position while the user assembles cover 18b to center section 16b. Such a configuration provides a simple mounting procedure that requires less time and effort than physically pushing and holding the diaphragm 20b into the seating position or charging an air chamber.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of mounting diaphragms to a pump, the method comprising:
reducing a pressure in a first pumping chamber defined by a first diaphragm and a first cover, the first cover mounted to a center section of the pump such that the first diaphragm is clamped between the first cover and the center section;
drawing the first diaphragm in a first direction into the first pumping chamber by the reduced pressure to draw a second diaphragm linked to the first diaphragm in the first direction and place the second diaphragm in a mounting position relative to the center section; and
mounting a second cover to the center section such that the second diaphragm is clamped between the second cover and the center section.

2. The method of claim 1, wherein reducing the pressure in the first pumping chamber defined by the first diaphragm and the first cover comprises:
plugging a first neck of the first cover to prevent airflow through the first neck; and
drawing air out of the first cover through a second neck of the first cover to reduce the pressure in the first pumping chamber.

3. The method of claim 2, wherein plugging the first neck of the first cover to prevent airflow through the first neck comprises:
fixing a cap to an inlet neck of the first cover to plug the inlet neck, the inlet neck forming the first neck.

4. The method of claim 2, wherein drawing the air out of the first cover through the second neck of the first cover to reduce the pressure in the first pumping chamber comprises:
drawing the air out of the first pumping chamber through a fitting supported by a cap fixed to an outlet neck of the first cover, the outlet neck forming the second neck.

5. The method of claim 1, wherein reducing the pressure in the first pumping chamber defined by the first diaphragm and the first cover comprises:
connecting a first cap to a first neck of the first cover to seal the first neck;
connecting a second cap to a second neck of the first cover; and
drawing air out of the first pumping chamber through the second cap to reduce the pressure in the first pumping chamber.

6. The method of claim 5, wherein reducing the pressure in the first pumping chamber defined by the first diaphragm and the first cover further comprises:
connecting a vacuum source to a fitting of the first cap, the vacuum source configured to cause the air to be drawn out of the first pumping chamber through the first cap.

7. The method of claim 6, wherein reducing the pressure in the first pumping chamber defined by the first diaphragm and the first cover further comprises:
providing a flow of compressed air to the fitting from the vacuum source; and
drawing the air out of the first pumping chamber by the fitting in response to the flow of compressed air.

8. The method of claim 5, wherein connecting the first cap to the first neck of the first cover comprises:
clamping the first cap to the first neck.

9. The method of claim 5, wherein connecting the second cap to the second neck of the first cover comprises:
clamping the second cap to the second neck.

10. The method of claim 1, further comprising:
returning the first pumping chamber to atmospheric pressure after the second diaphragm is mounted.

11. The method of claim 1, wherein drawing the first diaphragm in the first direction into the first pumping chamber by the reduced pressure to draw the second diaphragm linked to the first diaphragm in the first direction and place the second diaphragm in the mounting position relative to the center section comprises:
positioning the second diaphragm such that a bead of the second diaphragm is aligned with a receiver groove of a receiver of the center section.

12. The method of claim 11, wherein mounting the second cover to the center section such that the second diaphragm is clamped between the second cover and the center section further comprises:
positioning the second cover relative to the center section such that the bead of the second diaphragm is disposed within the receiver groove and a cover groove of the second cover.

13. The method of claim 1, wherein mounting the second cover to the center section such that the second diaphragm is clamped between the second cover and the center section comprises:
securing the second cover to the center section by a cover clamp.

14. A method of mounting diaphragms of a pump, the method comprising:
mounting a first diaphragm on the pump;
mounting a first cover to a center section of the pump to form a first chamber with the first diaphragm and the first cover;
developing a partial vacuum within the first chamber, development of the partial vacuum moving a connector by the first diaphragm to move a second diaphragm to engage the second diaphragm with a receiver of the pump; and
mounting a second cover to the receiver to secure the second diaphragm to the pump.

15. The method of claim 14, further comprising:
mounting a first cap on the first cover housing.

16. The method of claim 15, wherein the partial vacuum is developed by air movement through the first cap.

17. An apparatus for mounting a diaphragm of a pump, the apparatus comprising:
a first cap configured to seal with a first neck of a housing cover of the pump;
a second cap configured to seal with a second neck of the housing cover of the pump; and
a fitting supported by the first cap, the fitting configured to allow airflow through the first cap.

18. The apparatus of claim 17, wherein the fitting is a vacuum generator.

19. The apparatus of claim 17, wherein the second cap does not include an aperture therethrough.

20. The apparatus of claim 17, further comprising:
a first cover clamp configured to secure the first cap to the first neck; and
a second cover clamp configured to secure the second cap to the second neck.
